(19) United States
(12) Patent Application Publication
(10) Pub. No.: US 2026/0094141 A1
(43) Pub. Date: Apr. 2, 2026

(54) SYSTEMS AND METHODS FOR PROVIDING TRUSTED USER INTERFACE LAYOUTS

(71) Applicant: FISERV, INC., Milwaukee, WI (US)

(72) Inventors: Narayanan Gopalakrishnan, Newark, CA (US); Jacob Whitaker Abrams, San Mateo, CA (US); Jeffrey Blattman, San Jose, CA (US); Vinayak Kagalkar, Pleasanton, CA (US)

(73) Assignee: FISERV, INC., Milwaukee, WI (US)

(21) Appl. No.: 19/341,415

(22) Filed: Sep. 26, 2025

Related U.S. Application Data
(60) Provisional application No. 63/700,025, filed on Sep. 27, 2024.

(51) Int. Cl. G06Q 20/20; G06Q 20/38

(52) U.S. Cl. CPC G06Q 20/206; G06Q 20/38215

(57) ABSTRACT

A point-of-sale system may include a customer-facing device including a customer-facing display, one or more first processors, and a first non-transitory, computer-readable medium including first instructions, a merchant-facing device including a merchant-facing display, one or more second processors, a second non-transitory, computer-readable medium including second instructions which cause the one or more second processors to, receive a signed data structure from a certificate authority trusted by the customer-facing device, transmit the signed data structure to the customer-facing device, the data structure defining a user interface for display on the customer-facing display for performance of a transaction, wherein the first instructions cause the one or more first processors to authenticate the signed data structure, render the user interface defined in the signed data structure on the customer-facing display, and receive user input via the user interface related to the transaction.

### CROSS-REFERENCE TO RELATED APPLICATIONS

This application claims priority to U.S. Provisional Application No. 63/700,025, filed Sep. 27, 2024, which application is incorporated herein in its entirety.

### BACKGROUND

Point of sale (POS) systems including a merchant-facing display and a customer-facing display provide a convenient transaction flow, but the POS systems may be vulnerable to attack via the customer-facing displays.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art will appreciate the examples are illustrative, and are not intended to be limiting.

Aspects of the present disclosure are directed to a point-of-sale system including a customer-facing device including a customer-facing display, one or more first processors, and a first non-transitory, computer-readable medium including first instructions, a merchant-facing device including a merchant-facing display, one or more second processors, a second non-transitory, computer-readable medium including second instructions which, when executed by the one or more second processors, cause the one or more second processors to receive a signed data structure from a certificate authority trusted by the customer-facing device, transmit the signed data structure to the customer-facing device, the data structure defining a user interface for display on the customer-facing display for performance of a transaction, wherein the first instructions, when executed by the one or more first processors, cause the one or more first processors to authenticate the signed data structure, render the user interface defined in the signed data structure on the customer-facing display, and receive user input via the user interface related to the transaction.

In some implementations, the second instructions cause the one or more second processors to select the signed data structure from a set of signed data structures based on characteristics of the transaction. In some implementations, the characteristics of the transaction are received as input at the merchant-facing device. In some implementations, the user interface is not stored on the customer-facing device. In some implementations, user interface elements are stored on the customer-facing device, and wherein the signed data structure defines locations and contents of the user interface elements in the user interface. In some implementations, the first instructions cause the one or more first processors to transmit a response to the merchant-facing device based on the user input. In some implementations, the second instructions cause the one or more second processors to modify the transaction based on the response, wherein modifying the transaction includes one or more of approving the transaction, denying the transaction, cancelling the transaction, and adjusting an amount of the transaction. In some implementations, the signed data structure includes response instructions for the customer-facing device to respond to the merchant-facing device. In some implementations, the response instructions indicate that no response is to be sent to the merchant-facing device. In some implementations, the second instructions cause the one or more second processors to determine, based on the user input, whether to send a response to the merchant-facing device.

Aspects of the present disclosure are directed to a method including receiving, at a merchant-facing device, a signed data structure from a certificate authority trusted by a customer-facing device, transmitting, by the merchant-facing device, the signed data structure to the customer-facing device, the data structure defining a user interface for display on the customer-facing display for performance of a transaction, authenticating, by the customer-facing device, the signed data structure, rendering, by the customer-facing device, the user interface defined in the signed data structure, and receiving, at the customer-facing device, user input via the user interface related to the transaction.

In some implementations, the method includes selecting, by the merchant-facing device, the signed data structure from a set of signed data structures based on characteristics of the transaction. In some implementations, the characteristics of the transaction are received as input at the merchant-facing device. In some implementations, the user interface is not stored on the customer-facing device. In some implementations, user interface elements are stored on the customer-facing device, and wherein the signed data structure defines locations and contents of the user interface elements in the user interface. In some implementations, the method includes transmitting, by the customer-facing device, a response to the merchant-facing device based on the user input. In some implementations, the merchant-facing device modifies the transaction based on the response, wherein modifying the transaction includes one or more of approving the transaction, denying the transaction, cancelling the transaction, and adjusting an amount of the transaction. In some implementations, the signed data structure includes response instructions for the customer-facing device to respond to the merchant-facing device. In some implementations, the response instructions indicate that no response is to be sent to the merchant-facing device. In some implementations, the customer-facing device determines, based on the user input, whether to send a response to the merchant-facing device.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 illustrates an example point-of-sale (POS) system.

FIG. 2 is a block diagram of an example system for securely providing user interface layouts to a customer-facing device.

FIG. 3 is an example flow diagram of a method for securely providing user interface layouts to a customer-facing device of a POS system.

FIG. 4 is an example block diagram of a computing system 400.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

A point-of-sale (POS) system including a merchant-facing display and a customer-facing display provide a convenient transaction flow, but may be vulnerable to attack via the customer-facing display. An attacker may cause the customer-facing display to display a user interface (UI) for entering a PIN to steal a customer's PIN. Conventional solutions include executing a full operating system on the customer-facing device such that both the merchant-facing device are similar to full computers with a broad range of capabilities and hard-coding a set of preconfigured UIs on the customer-facing device. However, executing a full operating system on the customer-facing device requires powerful processors and imposes a computation burden on the customer-facing device. Further, hard-coding a set of preconfigured UIs on the customer-facing device does not allow for updating or modifying the UIs displayed on the customer-facing device. Examples and implementations discussed herein address these technological problems by providing signed user interface (UI) layouts to a customer-facing device from a merchant-facing device. The signed UI layouts can indicate the layout (position, size, orientation, text, etc.) of UI elements for rendering on the customer-facing device. The signed UI layouts can be signed by a signing entity that is trusted by the customer-facing device, such as a certificate authority. In this way, the customer-facing device can securely display UIs without executing its own operating system and incurring the computational burden associated with executing its own operating system, without storing the UIs in memory, and without restriction on the UIs that can be displayed. Furthermore, providing the signed UI layouts to the customer-facing device from the merchant-facing device allows for the display of new, updated, and modified UIs, as the UIs do not need to be stored on the customer-facing device.

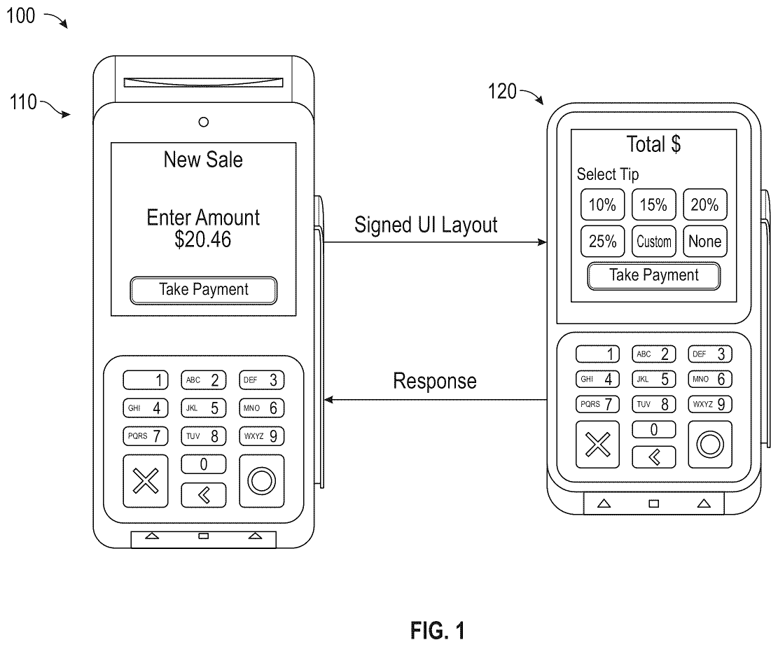

FIG. 1 illustrates an example point-of-sale (POS) system 100. The POS system 100 includes a merchant-facing device 110 and a customer-facing device 120. The merchant-facing device 110 can provide a signed user interface (UI) layout to the customer-facing device 120. The signed UI layout can be signed by a certificate authority trusted by the customer-facing device 120. The signed UI layout can indicate a layout (e.g., position, size, orientation, font, etc.) of UI elements for the customer-facing device 120 to render on its display. By providing the signed UI layout from the merchant-facing device 110 to the customer-facing device 120, the customer-facing device 120 is able to be a lightweight device that does not include a powerful processor or its own operating system. In contrast, if the customer-facing device 120 executed its own operating system for generating UIs based on input from the merchant-facing device 110, the customer-facing device 120 would need a more powerful processor. Moreover, by providing the signed UI layout from the merchant-facing device 110 to the customer-facing device 120, the customer-facing device 120 is able to display new and/or updated UIs, as opposed to being restricted to a set of UIs in memory. Additionally, by not storing the UIs in memory, the memory requirements of the customer-facing device 120 are reduced. Furthermore, by providing the signed UI layout from the merchant-facing device 110 to the customer-facing device 120, the POS system 100 prevents tampering with the customer-facing device 120 that attempts to cause the customer-facing device 120 to display a UI, such as a UI for receiving a PIN, as the customer-facing device 120 only renders UIs from signed UI layouts that are signed by a trusted signatory. Thus, by providing the signed UI layout from the merchant-facing device 110 to the customer-facing device 120, the POS system 100 is able to solve the technical problems of processor requirements for the customer-facing device 120, updating UIs of the customer-facing device 120, and preventing tampering with the customer-facing device 120 that attempts to cause the customer-facing device 120 to display a UI.

A connection between the merchant-facing device 110 and the customer-facing device 120 can be secure to prevent manipulation of the UIs displayed on the customer-facing device 120. In this way, the display of the UIs on the customer-facing device 120 can be secured in two separate ways: by securing the connection between the merchant-facing device 110 and the customer-facing device 120 and by requiring the UI layouts to be signed for the customer-facing device 120 to render the UIs.

The customer-facing device 120 can render a UI based on the signed UI layout and display the UI to a customer. The customer-facing device 120 can receive customer input via the UI. In some implementations, the customer-facing device 120 sends a response to the merchant-facing device 110 based on the customer input. In an example, the customer-facing device 120 sends a response to the merchant-facing device 110 indicating a tip amount for a transaction. In some implementations, the customer-facing device 120 does not send a response to the merchant-facing device. In an example, the customer facing device 120 receives a PIN and determines whether the PIN is valid, but does not transmit the PIN to the merchant-facing device 110 in order to increases a security of the PIN.

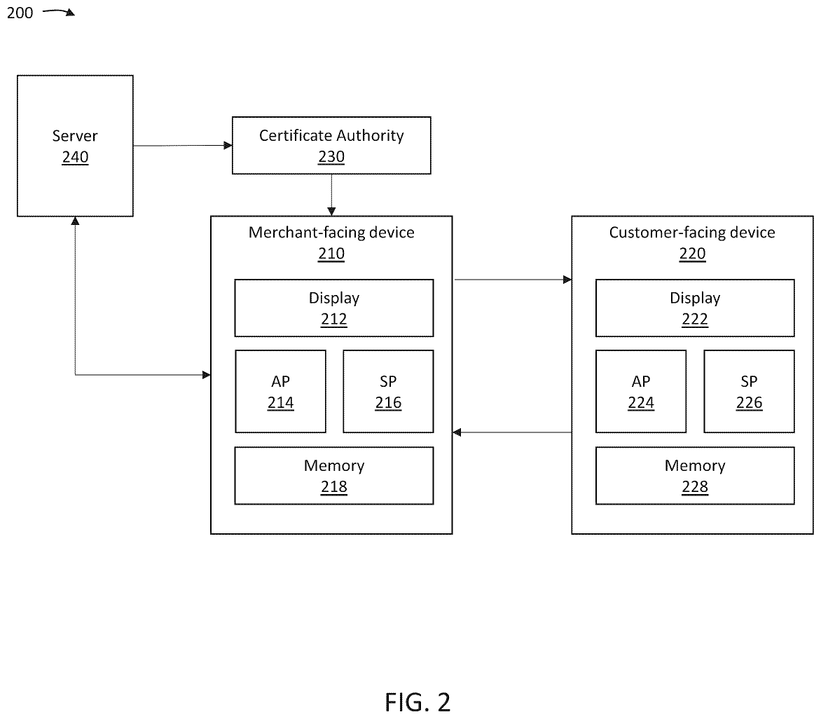

FIG. 2 is a block diagram of an example system 200 for securely providing user interface layouts to a customer-facing device 220. The system 200 includes a merchant-facing device 210, the customer-facing device 220, a certificate authority 230, and a server 240. The merchant-facing device 210 may be an example of the merchant-facing device 110 of FIG. 1. The customer-facing device 220 may be an example of the customer-facing device 120 of FIG. 1.

The merchant-facing device 210 includes a display 212, an applications processor 214, a secure processor 216, and a memory 218. The display 212 may be a touch display allowing for user input by tapping and/or swiping on a user interface. The display 212 may be controlled by the applications processor 214. The applications processor 214 may be a processor configured to execute instructions stored in the memory 218 to execute or instantiate an operating system and to implement a payments application for processing payments. The secure processor 216 may be a processor configured to execute instructions stored in the memory 218 to process payment information in a cryptographically secure manner. The secure processor 216 may encrypt payment information for transfer to a payment processor. Payment information may be kept secure by the secure processor 216 such that payment information is not shared with the applications processor 214. In some implementations, the applications processor 214 performs functions such as rendering user interfaces, navigating between user interfaces, and tracking items being purchased, while the secure processor 216 performs functions such as receiving payment information, encrypting payment information, and transferring payment information to a payment processor. The memory 218 may include separate instructions for execution by the applications processor 214 and the secure processor 216.

The applications processor 214 and the secure processor 216 may exchange messages regarding transactions. In some implementations, the applications processor 214 transmits a message to the secure processor 216 to transfer control to the secure processor 216 for the secure processor 216 to receive user input. The secure processor 216 may transmit a message to the applications processor to transfer control to the applications processor 214. In an example, the applications processor 214 receives transaction information such as items purchased and a transaction amount, and transfers control to the secure processor 216 to receive a tap payment from a transaction card. In this example, the secure processor encrypts the transaction card information in the tap payment and transmits the transaction card information to a payment processor. In this example, upon receiving an indication of approval of the transaction from the payment processor, the secure processor 216 indicates the approval to the applications processor 214 for the applications processor 214 to display the approval on the display 212 and complete the transaction.

The merchant-facing device 210 may receive a signed UI layout from the certificate authority 230. The signed UI layout may indicate a layout (position, size, orientation, text, etc.) of UI elements for rendering on the customer-facing device 220. An example of a signed UI layout is as follows:

```
{
  “elements”:{
    “button-1”:{
      “type”: “button”,
      “x”: 100,
      “y”: 200,
      “width”: 200,
      “height”: 50,
      “label”: “Click me!”
    },
    “textbox-1”: {
      “type”: “textbox”,
      “x”: 300,
      “y”: 100,
      “width”: 300,
      “height”: 30,
      “label”: “Hello, world!”
    },
    “label-1”:{
      “type”: “label”,
      “x”: 100,
      “y”: 50,
      “width”: 200,
      “height”: 20,
      “label”: “Hello, world!”
    }
  }
  “response_type”: “standard”
}
```

The signed UI layout may include a signature of the certificate authority 230. The signature may be a cryptographic signature generated using keys of a chain that is trusted by a chain of trust of the customer-facing device 220. The customer-facing device 220 may have previously established trust with the certificate authority 230. In an example, the customer-facing device 220 established trust with the certificate authority during manufacture of the customer-facing device 220. In an example, the customer-facing device 220 established trust with the certificate authority in a secure environment, before the customer-facing device 220 was deployed in the system 200.

The signed UI layout may include an indication of a response type, or an expected response. The response type may indicate to the customer-facing device 220 how to respond to the merchant-facing device 210. The response type may indicate whether to acknowledge the signed UI layout, whether to transmit user input using the rendered UI to the merchant-facing device, and/or a format of the response. In some implementations, the response type indicates that no response should be sent, or that no response is expected. In an example, a signed UI layout for a UI for receiving a PIN may include a response type of “PIN,” indicating that an acknowledgement of the signed UI layout should be sent and/or that an approval or denial of the transaction should be sent, but that the customer input (i.e., a PIN) should not be sent in a response.

The merchant-facing device 210 may store the signed UI layout in the memory 218. The merchant-facing device 210 may store multiple, or a set of signed UI layouts received from the certificate authority 230 in the memory 218. The merchant-facing device 210 may select a signed UI layout to send to the customer-facing device 220 based on characteristics of the transaction. In an example, if the transaction is a debit card transaction, the merchant-facing device 210 may select a signed UI layout for receiving a PIN. In an example, if the transaction includes an option for a tip, the merchant-facing device may select a signed UI layout for selecting a tip. In some implementations, the characteristics of the transaction are received at the merchant-facing device 210 as user input. In an example, the merchant enters merchant input at the merchant-facing device 210 including the transaction characteristics. In some implementations, the characteristics of the transaction are received at the customer-facing device 220 as user input. In an example, the customer enters customer input at the customer-facing device 220 including the transaction characteristics.

The merchant-facing device 210 sends the signed UI layout to the customer-facing device 220. The merchant-facing device 210 may encrypt the signed UI layout for transmission to the customer-facing device 220. The merchant-facing device 210 may transmit the signed UI layout to the customer-facing device 220 using a secure, trusted connection between the merchant-facing device 210 and the customer-facing device 220. In this way, the customer-facing device 220 can be protected against attack in three ways: 1) the secure, trusted connection prevents interception and/or insertion of transmissions between the merchant-facing device 210 and the customer-facing device 220, 2) the encryption of the signed UI layout prevents interception and/or insertion of transmissions between the merchant-facing device 210 and the customer-facing device 220, and 3) the signature requirement for UI layouts transmitted from the merchant-facing device 210 to the customer-facing device 220 prevents rendering at the customer-facing device of UI layouts inserted by an attacker.

The customer-facing device 220 receives the signed UI layout from the merchant-facing device 210. The customer-facing device 220 includes a display 222, a secure processor 226, and a memory 228. In some implementations, the customer-facing device 220 includes an applications processor 224. The secure processor 226 may be similar to the secure processor 216 of the merchant-facing device 210. The applications processor 224 is less powerful than the applications processor 214 of the merchant-facing device. As discussed herein, providing the signed UI layout to the customer-facing device 220 allows the customer-facing device 220 to have lower processing capabilities and to take on a lower computational load. The applications processor 224 may be capable of rendering the UI indicated in the signed UI layout.

The customer-facing device 220 authenticates the signed UI layout. The customer-facing device 220 may compare the signature in the signed UI layout to verify that the signature was generated using keys trusted by the customer-facing device 220. In some implementations, the customer-facing device 220 retrieves one or more keys from the memory 228 to authenticate the signed UI layout.

The customer-facing device 220 can render the UI indicated in the signed UI layout on the display 222. The display 222 can be similar to the display 212 of the merchant-facing device 210. In an example, the display 222 is a touch display. The customer-facing device 220 can retrieve, based on the signed UI layout, UI elements stored in the memory 228 and render the UI elements in the layout (position, orientation, size, content, etc.) indicated in the signed UI layout. In this way, the memory 228 can be sized (e.g., selected, designed) to store the UI elements but does not have to be so large as to store the UIs themselves. In this way, the memory burden on the customer-facing device for the UIs is reduced, as the customer-facing device 220 can store only the UI elements in the memory 228 for rendering according to the signed UI layouts.

The customer-facing device 220 can receive customer input via the user interface. The customer-facing device 220 can receive the customer input using the applications processor 224 or the secure processor 226 depending on the signed UI layout and/or the customer input. In an example, the applications processor 224 receives the customer input based on the signed UI layout defining a UI for receiving transaction information that is not payment information, such as an indication of a tip amount. In an example, the secure processor 226 receives the customer input based on the signed UI layout defining a UI for receiving payment information such as a card swipe, a card dip, a card tap, and/or a PIN.

The customer-facing device 220 can transmit a response to the merchant-facing device 210 based on the customer input. The customer-facing device 220 can transmit a response based on the response type in the signed UI layout. The customer-facing device 220 can determine, based on the response type and/or the customer input, whether to transmit a response to the merchant-facing device 210. In an example, the signed UI layout indicates that no response should be sent, but the customer-facing device determines, based on entry of an incorrect PIN, to transmit a response to the merchant-facing device 210 indicating entry of an incorrect PIN. In some implementations, the customer-facing device 220 processes the transaction by sending the transaction data to a payment processor for approval or denial. The customer-facing device 220 can send an approval message or a denial message to the merchant-facing device 210 based on a response from the payment processor. The customer-facing device 220 can send the response to the merchant-facing device 210 via a secure connection between the merchant-facing device 210 and the customer-facing device 220. The secure connection can be a wired or wireless connection. The customer-facing device 220 can encrypt the response to the merchant-facing device 210.

An example of a response from the customer-facing device 220 to the merchant-facing device is as follows:

```
{
  “response_from_cfd”: {
    “button-1”:{
      “current_state”: “pressed”,
      },
      “textbox-1”: {
        “current_value”: “$2.30”,
      },
      “checkbox-3”: {
        “current_state”: “selected”,
      },
    }
  }
}
```

In processing a single transaction, a series of signed UI layouts can be sent from the merchant-facing device 210 to the customer-facing device 220. The merchant-facing device 210 can determine a subsequent signed UI layout to send to the customer-facing device 220 based on the response received from the customer-facing device 220. In some implementations, the applications processor 214 of the merchant-facing device 210 implements a payment flow for executing the single transaction, where UIs are selected for the payment flow based on customer input received at the customer-facing device. The merchant-facing device 210 can modify the transaction based on responses received from the customer-facing device 220 (e.g., based on the customer input) to approve the transaction, deny the transaction, cancel the transaction, and adjust an amount of the transaction. In an example, the merchant-facing device 210 cancels the transaction based on a response from the customer-facing device 220 indicating customer input to cancel the transaction. In an example, the merchant-facing device 210 increases an amount of the transaction by a tip amount indicated in a response from the customer-facing device.

In some implementations, the merchant-facing device 210 requests signed UI layouts from the certificate authority 230. The merchant-facing device 210 may periodically request signed UI layouts from the certificate authority 230. The merchant-facing device 210 may request specific signed UI layouts from the certificate authority. In an example, the merchant-facing device 210 sends a UI layout to the certificate authority 230 for the certificate authority to sign the UI layout. In some implementations, the merchant-facing device 210 receives the UI layout from the server 240. In some implementations, the merchant-facing device 210 requests UI layouts or the signed UI layouts from the server 240. In some implementations, the merchant-facing device 210 receives a software update for the merchant-facing device 210 including UI layouts which the merchant-facing device 210 sends to the certificate authority 230 for signature. In some implementations, the merchant-facing device 210 receives a software update for the merchant-facing device 210 indicating that new or modified UI layouts are sent to the certificate authority 230 and that the certificate authority 230 will send signed UI layouts to the merchant-facing device 210. In this way, the merchant-facing device 210 can send dynamically-updated signed UI layouts to the customer-facing device 220.

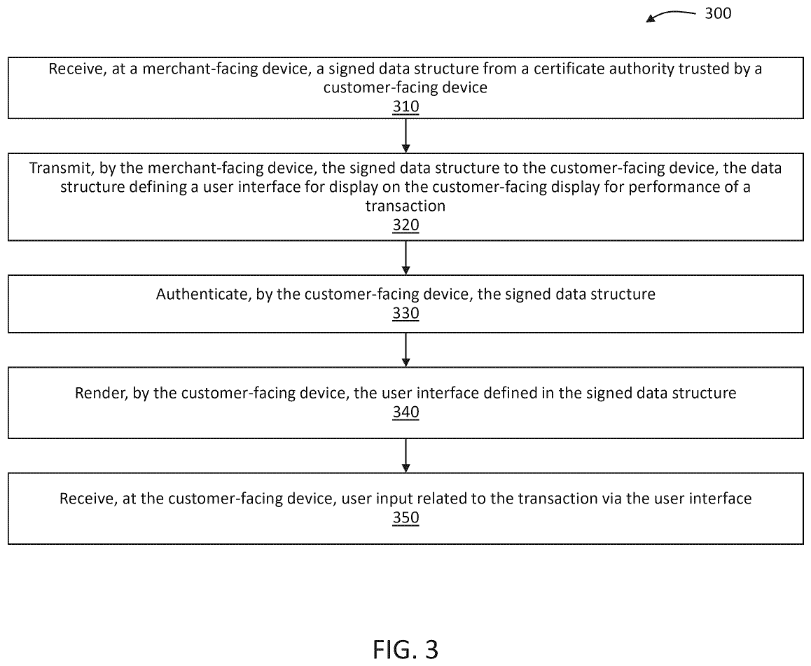

FIG. 3 is an example flow diagram of a method 300 for securely providing user interface layouts to a customer-facing device of a POS system. The method 300 may include more, fewer, or different operations than shown. The operations may be performed in the order shown or concurrently. The method 300 may be performed by the system 100 of FIG. 1 and/or the system 200 of FIG. 2.

At operation 310, a signed data structure (i.e., signed UI layout) is received at a merchant-facing device from a certificate authority trusted by a customer-facing device.

At operation 320, the signed data structure is transmitted by the merchant-facing device to the customer-facing device. The data structure defines a user interface for display on the customer-facing display for performance of a transaction. In some implementations, the signed data structure is stored in a memory of the merchant-facing device. The merchant-facing device can select the signed data structure from a set of signed data structures. The merchant-facing device can select the signed data structure based on characteristics of the transaction. The characteristics of the transaction can be determined by the merchant-facing device and/or received as input the merchant-facing device.

At operation 330, the signed data structure is authenticated by the customer-facing device. The customer-facing device may verify the signature of the signed data structure to determine that the signed data structure is signed by the trusted certificate authority. The customer-facing device may determine whether the signed data structure is signed using keys trusted by the customer-facing device. The customer-facing device may reject any UI data structure not signed by the trusted certificate authority or not signed using the trusted keys such that the corresponding UI is not rendered at the customer-facing device.

At operation 340, the user interface defined in the signed data structure is rendered by the customer-facing device. The user interface is not store at the customer-facing device. In some implementations, rendering the user interface includes retrieving user interface elements indicated in the signed data structure, where the signed data structure defines locations and/or contents of the user interface elements in the user interface. In an example, a button element is stored in the memory of the customer-facing device, and the signed data structure defines a location, size, color, and label for the button, causing the customer-facing device to render the button element in defined location with the defined size, color, and label.

At operation 350, user input related to the transaction is received at the customer-facing device via the user interface. The user input can include transaction information such as payment information (e.g., transaction card information, PIN, etc.) customer selections of various options (e.g., tip amount, payment type, etc.), and/or confirmation of transaction information.

In some implementations, the signed data structure includes response instructions for the customer-facing device to response to the merchant-facing device. In some implementations, the instructions indicate that no response is to be sent to the merchant-facing device. In some implementations, the customer-facing device determines, based on the user input, whether to send a response to the merchant-facing device. During a single transaction, multiple signed data structures can be sent from the merchant-facing device to the customer-facing device to render multiple user interfaces as part of a transaction flow. A first subset of the multiple signed data structures can indicate that a response is requested and/or a format of an expected response. A second subset of the multiple signed data structures can indicate that a response is not requested or that information should not be sent in a response. In some implementations, user interfaces for receiving payment information correspond to signed data structures of the second subset of the multiple signed data structures.

The merchant-facing device may modify the transaction based on the response received from the customer-facing device. The merchant-facing device may approve the transaction, deny the transaction, cancel the transaction, and/or adjust an amount of the transaction based on the response received from the customer-facing device.

In an example, the merchant-facing device receives a signed data structure from the certificate authority, the signed data structure corresponding to a new user interface for display on the customer-facing device during PIN entry. The merchant-facing device determines when in a payment flow the user interface is to be displayed and stores the signed data structure in memory. When the user interface is to be displayed on the customer-facing device (i.e., during PIN entry), the merchant-facing device sends the signed data structure to the customer-facing device. The customer-facing device authenticates the signed data structure by verifying that the signed data structure was signed by the certificate authority, retrieves user interface elements indicated in the signed data structure, and renders the user interface elements on the display of the customer-facing device according to instructions in the signed data structure. The customer-facing device receives customer input including the PIN via the user interface for PIN entry and determines whether the PIN is valid. The customer-facing device does not transmit the PIN to the merchant-facing device but instead encrypts the PIN and transmits the PIN to the customer's bank for validation. Based on the PIN being correct (receiving confirmation from the bank), the customer-facing device sends an indication of a correct PIN to the merchant-facing device. In this way, the merchant-facing device can control the display of user interfaces on the customer-facing device to display new and modified user interfaces without updating the customer-facing device. Additionally, the customer-facing device can be a lightweight device with lower processing power and storage than the merchant-facing device.

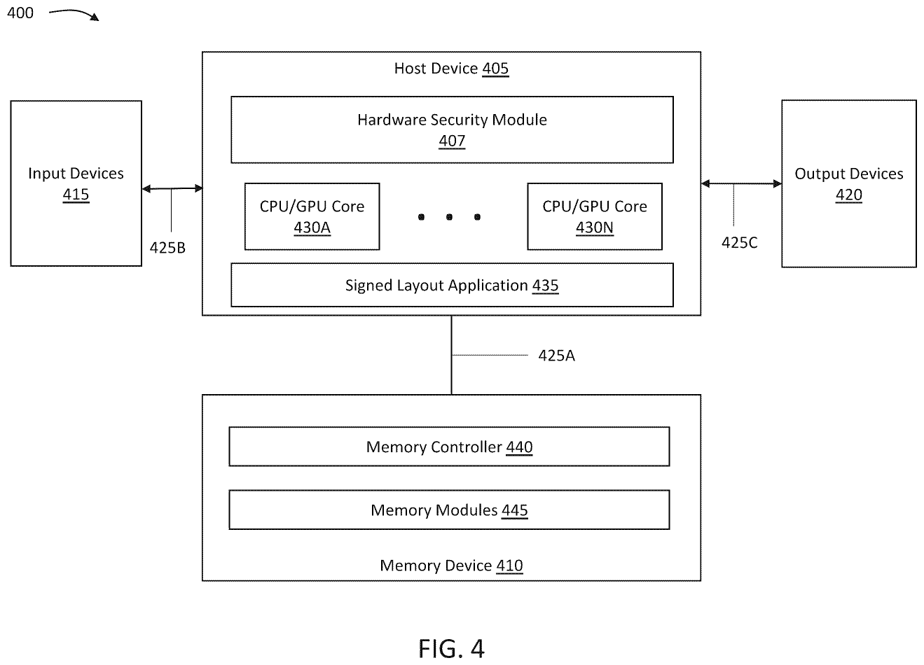

FIG. 4 is an example block diagram of a computing system 400, in accordance with some embodiments of the present disclosure. The computing system 400 includes a host device 405 associated with a memory device 410. The host device 405 may be configured to receive input from one or more input devices 415 and provide output to one or more output devices 420. The host device 405 may be configured to communicate with the memory device 410, the input devices 415, and the output devices 420 via appropriate interfaces or channels 425A, 425B, and 425C, respectively. The computing system 400 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 405.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 400) may be implemented by multiple computing devices in a distributed environment, and vice versa.

The input devices 415 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 405 and that allows an external source, such as a user, computer, or database, to enter information (e.g., data) into the host device and send instructions to the host device 405. Similarly, the output devices 420 may include a variety of output technologies such as external memories, databases, printers, speakers, displays, microphones, light emitting diodes, headphones, plotters, speech generating devices, video devices, and any other output peripherals that are configured to receive information (e.g., data) from the host device 405. The “data” that is either input into the host device 405 and/or output from the host device may include any of a variety of textual data, graphical data, video data, sound data, position data, combinations thereof, or other types of analog and/or digital data that is suitable for processing using the computing system 400.

The host device 405 may include one or more Central Processing Unit (“CPU”) or Graphics Processing Unit (“GPU”) cores or processors 430A-430N that may be configured to execute instructions for running one or more applications associated with the host device 405. In some embodiments, the instructions and data needed to run the one or more applications may be stored within the memory device 410. The host device 405 may also be configured to store the results of running the one or more applications within the memory device 410. One such application on the host device 405 may include a signed layout application 435. The signed layout application 435 may be executed by one or more of the CPU/GPU cores 430A-430N. The instructions to execute the signed layout application 435 may be stored within the memory device 410. The signed layout application 435 is described in greater detail above and may perform functions such as described in FIGS. 1-3 and/or methods such as the method 300 of FIG. 3. Thus, the host device 405 may be configured to request the memory device 410 to perform a variety of operations. For example, the host device 405 may request the memory device 410 to read data, write data, update or delete data, and/or perform management or other operations.

The host device 405 may include a hardware security module 407. The hardware security module 407 may be a physical device (hardware) which performs encryption and decryption functions. The hardware security module 407 may be used by the host device 405 to generate cryptographic keys, encrypt messages, and/or decrypt messages for communicating with merchant systems and issuer systems.

To facilitate communication with the memory device 410, the memory device 410 may include or be associated with a memory controller 440. Although the memory controller 440 is shown as being part of the memory device 410, in some embodiments, the memory controller 440 may instead be part of the host device 405 or another element of the computing system 400 and operatively associated with the memory device 410. The memory controller 440 may be configured as a logical block or circuitry that receives instructions from the host device 405 and performs operations in accordance with those instructions. For example, when the execution of the signed layout application 435 is desired, the host device 405 may send a request to the memory controller 440. The memory controller 440 may read the instructions associated with the signed layout application 435 that are stored within the memory device 410, and send those instructions back to the host device. In some embodiments, those instructions may be temporarily stored within a memory on the host device 405. One or more of the CPU/GPU cores 430A-430N may then execute those instructions by performing one or more operations called for by those instructions of the signed layout application 435.

The memory device 410 may include one or more memory circuits 445 that store data and instructions. The memory circuits 445 may be any of a variety of memory types, including a variety of volatile memories, non-volatile memories, or a combination thereof. For example, in some embodiments, one or more of the memory circuits 445 or portions thereof may include NAND flash memory cores. In other embodiments, one or more of the memory circuits 445 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 410. In some embodiments, one or more of the memory circuits 445 or portions thereof may be configured as other types of storage class memory (“SCM”). Generally speaking, the memory circuits 445 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 400 are shown and described in FIG. 4. However, the computing system 400 may include other components such as various batteries and power sources, networking interfaces, routers, switches, external memory systems, controllers, etc. Generally speaking, the computing system 400 may include any of a variety of hardware, software, and/or firmware components that are needed or considered desirable in performing the functions described herein. Similarly, the host device 405, the input devices 415, the output devices 420, and the memory device 410, including the memory controller 440 and the memory circuits 445, may include hardware, software, and/or firmware components that are considered necessary or desirable in performing the functions described herein. In addition, in certain embodiments, the memory device 410 may integrate some or all of the components of the host device 405, including, for example, the CPU/GPU cores 430A-430N, and the CPU/GPU cores may be configured to execute the signed layout application 435, as described herein.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A point-of-sale system comprising:
a customer-facing device including:
a customer-facing display;
one or more first processors; and
a first non-transitory, computer-readable medium including first instructions; and
a merchant-facing device including:
a merchant-facing display;
one or more second processors; and
a second non-transitory, computer-readable medium including second instructions which, when executed by the one or more second processors, cause the one or more second processors to:
receive a signed data structure from a certificate authority trusted by the customer-facing device;
transmit the signed data structure to the customer-facing device, the signed data structure defining a user interface for display on the customer-facing display for performance of a transaction, wherein the first instructions, when executed by the one or more first processors, cause the one or more first processors to:
authenticate the signed data structure;
render the user interface defined in the signed data structure on the customer-facing display; and
receive user input related to the transaction via the user interface.

2. The point-of-sale system of claim 1, wherein the second instructions cause the one or more second processors to select the signed data structure from a set of signed data structures based on characteristics of the transaction.

3. The point-of-sale system of claim 2, wherein the characteristics of the transaction are received as input at the merchant-facing device.

4. The point-of-sale system of claim 1, wherein the user interface is not stored on the customer-facing device.

5. The point-of-sale system of claim 4, wherein user interface elements are stored on the customer-facing device, and wherein the signed data structure defines locations and contents of the user interface elements in the user interface.

6. The point-of-sale system of claim 1, wherein the first instructions cause the one or more first processors to transmit a response to the merchant-facing device based on the user input.

7. The point-of-sale system of claim 6, wherein the second instructions cause the one or more second processors to modify the transaction based on the response, wherein modifying the transaction includes one or more of approving the transaction, denying the transaction, cancelling the transaction, and adjusting an amount of the transaction.

8. The point-of-sale system of claim 1, wherein the signed data structure includes response instructions for the customer-facing device to respond to the merchant-facing device.

9. The point-of-sale system of claim 8, wherein the response instructions indicate that no response is to be sent to the merchant-facing device.

10. The point-of-sale system of claim 8, wherein the second instructions cause the one or more second processors to determine, based on the user input, whether to send a response to the merchant-facing device.

11. A method comprising:
receiving, at a merchant-facing device, a signed data structure from a certificate authority trusted by a customer-facing device;
transmitting, by the merchant-facing device, the signed data structure to the customer-facing device, the signed data structure defining a user interface for display on the customer-facing device for performance of a transaction;
authenticating, by the customer-facing device, the signed data structure;
rendering, by the customer-facing device, the user interface defined in the signed data structure; and
receiving, at the customer-facing device, user input related to the transaction via the user interface.

12. The method of claim 11, further comprising selecting, by the merchant-facing device, the signed data structure from a set of signed data structures based on characteristics of the transaction.

13. The method of claim 12, wherein the characteristics of the transaction are received as input at the merchant-facing device.

14. The method of claim 11, wherein the user interface is not stored on the customer-facing device.

15. The method of claim 14, wherein user interface elements are stored on the customer-facing device, and wherein the signed data structure defines locations and contents of the user interface elements in the user interface.

16. The method of claim 11, further comprising transmitting, by the customer-facing device, a response to the merchant-facing device based on the user input.

17. The method of claim 16, wherein the merchant-facing device modifies the transaction based on the response, wherein modifying the transaction includes one or more of approving the transaction, denying the transaction, cancelling the transaction, and adjusting an amount of the transaction.

18. The method of claim 11, wherein the signed data structure includes response instructions for the customer-facing device to respond to the merchant-facing device.

19. The method of claim 18, wherein the response instructions indicate that no response is to be sent to the merchant-facing device.

20. The method of claim 19, wherein the customer-facing device determines, based on the user input, whether to send a response to the merchant-facing device.
